(19) United States
(12) Patent Application Publication
(10) Pub. No.: US 2018/0157996 A1
(43) Pub. Date: Jun. 7, 2018

(54) Graphical User Interface to Enable Modification of Multi-Segment Travel Itineraries

(71) Applicant: GOOGLE INC., Mountain View, CA (US)

(72) Inventors: Adam Eijdenberg, San Jose, CA (US); Todd A. Williamson, Mountain View, CA (US)

(21) Appl. No.: 15/369,653

(22) Filed: Dec. 5, 2016

(51) Int. Cl. G06Q 10/02; G06Q 30/02; G06F 3/0482

(52) U.S. Cl. CPC G06Q 10/02; G06F 3/0482; G06Q 30/0283

(57) ABSTRACT

The disclosure generally describes computer-implemented methods, computer-readable media, and systems for selecting a feature per flight segment associated with a multi-segment travel itinerary. One computer-implemented method includes receiving data associated with a multi-segment travel itinerary, determining, by operation of a computer, a plurality of interactive informational elements, wherein each interactive informational element of the plurality of interactive informational elements represents an available feature for a segment associated with the multi-segment travel itinerary, designating a determined interactive informational element per feature type for each flight segment, and initiating a presentation of the plurality of interactive informational elements as part of a single graphical user interface.

### TECHNICAL FIELD

The present disclosure relates to providing graphical user interfaces for display, and specifically to providing graphical user interfaces to enable modification of multi-segment travel itineraries.

### BACKGROUND

In conventional systems, users and agents pose queries to computer itinerary planning systems. In response to a query for a multi-segment travel itinerary, the computer itinerary planning system returns, in various possible forms, a list of possible solutions, and each solution includes information for each segment of the multi-segment travel itinerary. However, the system only allows the same cabin type for all segments of an itinerary.

### SUMMARY

Techniques herein provide computer-implemented methods to render graphical user interfaces comprising multiple, interrelated components generated in response to a request for an itinerary. Feature data for an itinerary is received for the multi-segment travel itinerary. Multiple interactive informational elements, each representing an available feature for an associated segment of the multi-segment travel itinerary, are displayed as part of a single graphical user interface, with a designated interactive informational element for each feature per segment.

The present disclosure relates to computer-implemented methods, software, and systems for selecting a feature per segment associated with a multi-segment travel itinerary. One computer-implemented method includes receiving segment data, feature data, and other relevant data associated with a multi-segment travel itinerary, determining, by operation of a computer, a plurality of interactive informational elements, wherein each interactive informational element of the plurality of interactive informational elements represents an available feature for a segment associated with the multi-segment travel itinerary, designating a determined interactive informational element per feature for each segment, and initiating a presentation of the plurality of interactive informational elements as part of a single graphical user interface.

In an example, a system receives a request for an itinerary comprising a plurality of segments. The system identifies one or more solutions associated with an itinerary, each solution including a plurality of segment identifiers, each segment identifier associated with one or more user-selectable feature type identifiers, each user-selectable feature type identifier having an associated value associated with a feature. The system may determine a feature type identifier having a lowest associated value associated with the feature for each segment identifier based on the one or more solutions. The system designates an initial feature type identifier for each segment identifier based on the determined feature type identifier having the lowest associated value associated with the feature, wherein the designated initial feature type identifier represents a currently selected feature type identifier for each segment identifier.

In an example, the system provides instructions to a user computing device causing the user computing device to render a graphical user interface, the graphical user interface comprising a grid comprising one or more feature type identifiers along a horizontal axis and one or more segment identifiers along a vertical axis and one or more interactive information elements arranged in the grid, each of the one or more interactive information elements representing a particular feature type identifier corresponding to a particular segment identifier, wherein the designated initial feature type identifier is depicted as the currently selected feature type identifier for each segment identifier in the graphical user interface.

At a time after presenting the graphical user interface, an input of a selection of a first interactive information element in the graphical user interface representing a first feature type identifier corresponding to a first segment identifier may be received, the first feature type identifier associated with the selected interactive information element for the first fsegment identifier being different than the designated initial feature type. In response to receiving the input of a selection of an interactive informational element associated with a feature corresponding to the first segment, providing instructions to render an updated graphical user interface, the updated graphical user interface comprising a grid comprising the one or more cabin type identifiers along the horizontal axis and the one or more flight segment identifiers along the vertical axis and one or more interactive information elements arranged in the grid, each of the one or more interactive information elements representing a particular feature corresponding to a particular segment, wherein the first feature associated with the selected interactive information element is depicted as the currently selected feature for the first segment in the graphical user interface, and wherein the designated initial feature identifier is depicted as the currently selected feature for a second flight segment identifier in the graphical user interface

The subject matter described in this disclosure can be implemented in particular implementations so as to realize one or more of the following advantages. First, features for each option of a specific set of options for a multi-segment travel itinerary may be selected to compare different particular features for different combinations. Further, an optimized feature for the multi-segment travel itinerary may be available if specific combinations of segments comprising particular features are selected. Other advantages will be apparent to those skilled in the art.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example system for selecting a cabin per flight segment associated with a multi-flight-segment air-travel itinerary.

FIG. 2 is a flow chart illustrating a method to calculate and filter cabin combinations for flight segments associated with a multi-flight-segment air-travel itinerary to display on a graphical user interface.

FIG. 3A is a block diagram illustrating an example partial set and relationships between filtered, priced, ordered cabin permutations for flight segments associated with a multi-flight-segment air-travel itinerary following the method of FIG. 2.

FIG. 3B is a block diagram illustrating additional cabin permutations and relationships of the example filtered, priced, ordered cabin permutations for flight segments associated with a multi-flight-segment air-travel itinerary following the method of FIG. 2.

FIG. 4 is a flow chart illustrating a method of displaying information for a multi-flight-segment air-travel itinerary.

FIG. 5 is a block diagram illustrating an example GUI displaying a plurality of determined interactive informational elements.

FIG. 6 is a block diagram illustrating an example GUI displaying a plurality of different determined interactive informational elements.

FIG. 7 is a block diagram illustrating an example GUI displaying updated interactive informational elements following the detection of a hover event.

FIG. 8 is a block diagram illustrating an example GUI displaying updated interactive informational elements following the detection of a different hover event.

FIG. 9 is a block diagram illustrating an example alternate GUI illustrating the selection of interactive informational elements by selecting a desired fare for the represented air-travel itinerary.

### DETAILED DESCRIPTION OF EXAMPLE EMBODIMENTS

### Overview

The example embodiments described herein provide computer-implemented techniques for selecting a cabin per flight segment associated with a multi-flight-segment air-travel itinerary.

Travelers and travel agents pose air-travel planning queries to a computer travel planning system (TPS). TPSs may be accessed using, for example, travel web sites, airline-specific web sites, or interfaces supplied by global distribution systems used by travel agents. One type of query typically supported by TPSs is the so-called low-fare-search (LFS) query. LFS queries often allow searching for a cabin (e.g., coach, business-class, first-class, etc.) for all flights of the multi-flight-segment air-travel itinerary. In response to an LFS query for a multi-flight-segment air-travel itinerary, the TPSs return, in various possible forms, a list of possible air-travel solutions, and each air-travel solution includes flight and price information for each flight-segment of the multi-flight-segment air-travel itinerary. However, existing TPSs do not offer the ability to select a cabin for each flight of a specific set of flights for a multi-flight-segment air-travel itinerary. Allowing the selection of a cabin per flight segment allows a comparison of different pricing options for different cabin combinations for the set of flights.

For the purposes of this disclosure, a “flight segment” means one instance of an aircraft taking off and landing for a specific air-carrier/flight number. A “flight” is a collection of one or more flight segments. For example, for airport locations A, B, and C, a flight may be a “one-way trip”, A→B, A→B→C, etc.; a “round trip”, A→B→A, or AàBàcàA; an “open jaw”, A→B and C→A or A→B and B→C; a “circle trip”, A→B→C→A; etc. Other flight configurations are also possible. A→B, indicating “from A to B”, or other paths as described above for a flight may alternatively be represented with a hyphen or other symbol between the airport locations or in any other suitable manner. For example, A-B also indicates “from A to B.” For the purposes of this disclosure, an “air-travel itinerary” means one or more flights segments which together define a desired complete air-travel route, for example a round trip as described above. For the purposes of this disclosure, a “fare” is the cost of one or more flight segments making up a flight.

The foregoing and other implementations can each optionally include one or more of the following features:

A first example, combinable with the general implementation, wherein, simultaneously, each of the plurality of interactive informational elements displays, as an indication of a particular feature, at least one of an indication that the represented available feature is included in the multi-segment travel itinerary or an indication of a change in the particular feature of the multi-segment travel itinerary if the interactive informational element is selected.

A second example, combinable with the general implementation, wherein, simultaneously, the designated interactive informational elements indicate an optimization of a feature for each flight segment associated with the multi-segment travel itinerary.

A third example, combinable with any of the previous examples, further comprising instructions operable to temporarily update the indication of the particular feature from a first value to a second value for at least one interactive informational element presented simultaneously with another interactive informational element upon receiving a hover event over the another interactive informational element.

A fourth example, combinable with any of the previous examples, further comprising operations operable to revert the temporarily updated indication of the particular feature from the second value to the first value for the at least one interactive informational element upon receiving a no-hover event associated with the another interactive informational element.

A fifth example, combinable with any of the previous examples, further comprising instructions operable to update the indication of the particular feature from a first value to a second value for at least one interactive informational element presented simultaneously with another interactive informational element upon receiving a selection event associated with the another interactive informational element, wherein the received selection event designates the another interactive information element.

A sixth example, combinable with any of the previous examples, further comprising operations operable to designate at least one interactive informational element presented simultaneously with another interactive informational element upon receiving a selection event associated with the another interactive informational element, wherein the received selection event designates the another interactive informational element.

A seventh example, combinable with any of the previous examples, further comprising operations operable to update the indication of the particular feature for the at least one interactive informational element.

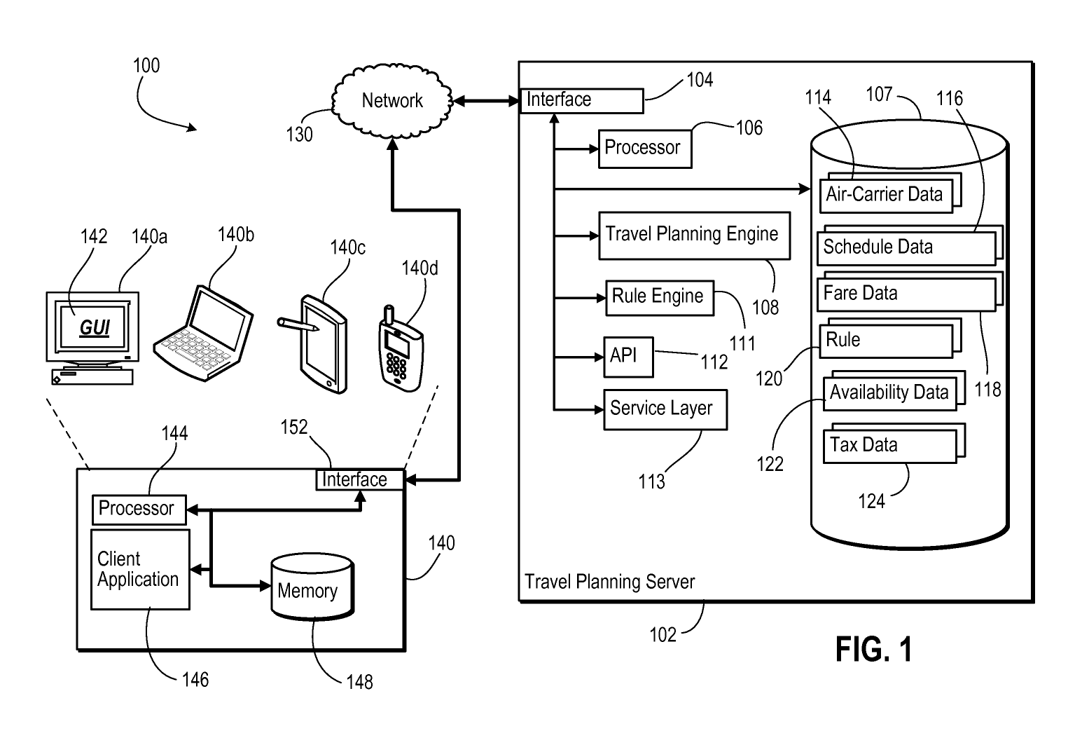

Referring to FIG. 1, an example travel planning system 100 is shown. The illustrated travel planning system 100 includes, or is communicably coupled with, a travel planning server 102 and a client 140 communicating across a network 130. While FIG. 1 depicts a client-server environment, FIG. 1 could also represent a cloud-computing environment.

In general, the example travel planning system 100 depicts an example configuration of a system for selecting a cabin per flight segment associated with a multi-flight-segment air-travel itinerary. In alternative implementations, the elements illustrated within the travel planning server 102 and/or the at least one client 140 may be included in or associated with different and/or additional servers, clients, networks, or locations other than those illustrated in FIG. 1. Additionally, the functionality associated with the travel planning server 102 may be associated with any suitable system, including by adding additional instructions, programs, applications, or other software to existing systems. For example, the components illustrated within the travel planning server 102 may be included in multiple servers, cloud-based networks, or other locations accessible to the travel planning server 102 (e.g., either directly or through network 130).

At a high level, the travel planning server 102 is an electronic computing device operable to receive, transmit, process, store, or manage data and information associated with the example travel planning system 100. Through a graphical user interface (GUI), a travel-planning server 102 user, for example using a client 140, is provided with an efficient and user-friendly presentation of data provided by or communicated within the example travel planning system 100.

In general, the travel planning server 102 is responsible for receiving application requests from a client 140 (as well as any other entity or system interacting with the travel planning server 102), for example to select a cabin per flight segment associated with an air-travel itinerary, responding to the received requests by processing said requests in an associated travel planning engine 108, and sending the appropriate responses from the travel planning engine 108 back to the requesting client 140 or other requesting system. The travel planning engine 108 can also process and respond to local requests from a user accessing the associated travel planning server 102. Accordingly, in addition to requests from the client 140, requests associated with a particular travel planning engine 108 may also be sent from internal users, external or third-party customers, other applications, and/or any other appropriate entities, individuals, systems, or computers. According to one implementation, travel planning server 102 may also include or be communicably coupled with an e-mail server, a web server, a caching server, a streaming data server, and/or other suitable server. In other implementations, the travel planning server 102 and related functionality may be provided in a cloud-computing environment.

In some implementations, the travel planning server 102 can store and execute various other applications (not illustrated), while in other implementations, the travel planning server 102 may be a dedicated server meant to store and execute a particular travel planning engine 108 and related functionality. In some implementations, the travel planning server 102 can contain a web server or be communicably coupled with a web server, where the particular travel planning engine 108 associated with that travel planning server 102 represents a web-based (or web-accessible) application accessed and/or executed on an associated client 140 to perform the programmed tasks or operations of the corresponding travel planning engine 108. In some implementations, the travel planning engine 108 can execute functionality associated with other local, remotely networked, and/or cloud-based applications (not illustrated). In still other implementations, the travel planning engine 108 may be executed on a first system, while the travel planning engine 108 manipulates and/or provides information for data located at a remote, second system.

The travel planning server 102 includes an interface 104. Although illustrated as a single interface 104 in FIG. 1, two or more interfaces 104 may be used according to particular needs, desires, or particular implementations of the example travel planning system 100. The interface 104 is used by the travel planning server 102 for communicating with other systems in a distributed environment—including within the example travel planning system 100—connected to the network 130; for example, the client 140, as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example travel planning system 100.

Generally, the travel planning server 102 may be communicably coupled with a network 130 that facilitates communications between the components of the example travel planning system 100 (e.g., between the travel planning server 102 and the at least one client 140), as well as with any other local or remote computer, such as additional clients, servers, or other devices communicably coupled to network 130, including those not illustrated in FIG. 1. In the illustrated example travel planning system 100, the network 130 is depicted as a single network, but may be comprised of more than one network without departing from the scope of this disclosure, so long as at least a part of the network 130 may facilitate communications between senders and recipients. The network 130, however, is not a required component in some implementations of the present disclosure.

The travel planning server 102 includes a processor 106. Although illustrated as a single processor 106 in FIG. 1, two or more processors may be used according to particular needs, desires, or particular implementations of the example travel planning system 100. Generally, the processor 106 executes instructions and manipulates data to perform necessary operations of the travel planning server 102. Specifically, the processor 106 executes the functionality required to receive and respond to requests from the client 140 and/or to select a cabin per flight segment associated with a multi-flight-segment air-travel itinerary.

The travel planning server 102 also includes a memory 107 that holds data for the travel planning server 102. Although illustrated as a single memory 107 in FIG. 1, two or more memories may be used according to particular needs, desires, or particular implementations of the example travel planning system 100. While memory 107 is illustrated as an integral component of the travel planning server 102, in alternative implementations, memory 107 can be external to the travel planning server 102 and/or the example travel planning system 100. In some implementations, the memory 107 includes at least one carrier data 114 instance, at least one schedule data 116 instance, at least one fare data 118 instance, at least one rule 120 instance, at least one availability data instance 122, and at least one tax data 124 instance. Availability data 122 is used by an air carrier to determine, from instant to instant, a price point at which seats can be sold in a particular cabin for a particular flight segment/flight. In some implementations, availability data can be acquired by a real-time communication with an airline information system and/or retrieved from cached data on or computed at a local computing system, for example a TPS. Tax data 124 refers to a local database of the taxes charged on airline tickets by each country of the world. In some implementations, taxes can vary with the cabin class chosen for each flight segment. In some implementations, the at least one carrier data 114 instance, the at least one schedule data 116 instance, the at least one fare data 118 instance, the at least one rule 120 instance, the at least one availability data instance 122, and/or the at least one tax data 124 instance may reside either locally or remote (e.g., by using a reference) to the travel planning server 102. The at least one carrier data 114 instance, the at least one schedule data 116 instance, the at least one fare data 118 instance, the at least one rule 120 instance, the at least one availability data instance 122, and/or the at least one tax data 124 instance may be accessed, for example, via a web service, a remote access system or software, a local or remote client 140, or other suitable system component.

In some implementations, the at least one air-carrier data 114 instance represents an air carrier name, address, identification number, abbreviation, countries of service, airport hub, or any other suitable data with respect to an air carrier. For example, a particular air carrier may have data stored in the at least one air-carrier data 114 instance as the name “Airborne Rider Airlines”, address “1234 Airport Row, Flight City, Tex. 75001”, identification number “3170”, abbreviation “ARA”, countries of service “US and UK”, and airport hub “DFW.” Other representations and types of air-carrier data may be used and/or stored without departing from the scope of the disclosure. The at least one air-carrier data 114 instance may be accessed, for example, using a web service, a remote access system or software, a local or remote client 140, or other suitable system component.

The at least one schedule data 116 instance may store information about one or more flights. For example, data for a flight may be represented as “10OCT12 BOS ARA101(BEB/Y99W10J10F6) LHR 11OCT12 BEB301(BEB/Y50J10F8) FRA.” In this example, two flight segments making up a single flight from Boston, Mass. USA (BOS) to Frankfurt Airport Germany (FRA) are represented as: 1) “Departing on Oct. 10, 2012, BOSLHR marketed as air carrier ARA, flight 101 (operated by carrier BEB and configured with available cabin types of Y/W/J/F—coach/premium economy/business/first class, respectively—99/10/10/6 seats of each type, respectively)” and 2) “Departing on Oct. 11, 2012, LHR-FRA on air carrier BEB, flight 301 (operated by carrier BEB and configured with available cabin types of Y/J/F—coach/business class/first class, respectively—50/10/8 seats of each type, respectively).” The illustrated example flight data 118 is to be considered representative only, and one of ordinary skill will appreciate that in other implementations, the schedule data 116 may be represented in numerous other ways without departing from the scope of the disclosure.

The at least one fare data 118 instance represents price data and/or conditions used to determine a fare associated with one or more flight segment. In some implementations, fare data 118 may also include, for example, air carriers, origin/destination endpoints, flight segment pricing data, conditions for application of the fare, or other suitable data associated with the fare. In some implementations, schedule data 116 and fare data 118 can be combined in whole or in part, for example “10OCT12 BOS ARA101(BEB/Y99W10J10F6) LHR 1275 11OCT12 BEB301(BEB/Y50J10F8) FRA 995.” In this example, schedule data 116 (as described above) now includes combined fare data 118 for the two example flight segments. Flight ARA101 now includes a fare of $1275, while flight BEB301 includes a fare of $995. The illustrated example fare data 118 is to be considered representative only, and one of ordinary skill will appreciate that in other implementations, the fare data may be represented in numerous other ways without departing from the scope of the disclosure.

The rule engine 111 can be any application, program, module, process, or other software that may provide methods to evaluate and/or execute the at least one rule 120 instance to support calculating and/or selecting a cabin per flight segment associated with a multi-flight-segment air-travel itinerary. In some implementations, the rule engine 111 can partially or completely generate a GUI interface presenting available cabin combinations. The at least one rule 120 instance may represent conditions, parameters, variables, algorithms, instructions, constraints, references, and any other appropriate information for selecting a cabin per flight segment associated with a multi-flight-segment air-travel itinerary. In some implementations, the at least one rule 120 instance may define, for example, valid and/or available cabin combinations per flight, and/or price modification based upon one or more selected cabin types, GUI modification based upon interaction with GUI elements, and/or filtering criteria to determine available cabin combinations. In some implementations, the at least one rule 120 can be supplied by individual air carriers, a consortium of air carriers, a third-party, or other suitable data source. In some implementations, a travel planning server 102 user can define rules associated with the at least one rule 120 instance.

A travel planning engine 108 is illustrated within the travel planning server 102. Although illustrated as a single travel planning engine 108 in the travel planning server 102, two or more travel planning engines 108 may be used in the travel planning server 102 according to particular needs, desires, or particular implementations of the specific environment. The travel planning engine 108 can be any application, program, module, process, or other software that may provide methods for selecting on a GUI a cabin per flight segment associated with a multi-flight-segment air-travel itinerary. In some implementations, the travel planning application accesses, processes, and/or modifies data associated with the at least one carrier data 114 instance, the at least one schedule data 116 instance, the at least one fare data 118 instance, and the at least one rule 120 instance. In some implementations, the travel engine 108 can determine a set of filtered available cabin combinations. In some implementations, a particular travel planning engine 108 can operate in response to and in connection with at least one request received from an associated client 140. Additionally, a particular travel planning engine 108 may operate in response to and in connection with at least one request received from other travel planning engines 108, including travel planning engines 108 associated with other travel planning servers 102. In some implementations, each travel planning engine 108 can represent a web-based application accessed and executed by one or more remote clients 140 across the network 130 (e.g., through the Internet, or using at least one cloud-based service associated with the travel planning engine 108). For example, part of a particular travel planning engine 108 may be a web-based service associated with a travel planning engine 108 that is remotely called, while another part of the particular travel planning engine 108 may be an interface object or agent bundled for processing at a remote client 140. Moreover, any or all of a particular travel planning engine 108 may be a child or sub-module of another software module or enterprise application (not illustrated). Still further, parts of the particular travel planning engine 108 may be executed or accessed by a user working directly at the travel planning server 102, as well as remotely at a corresponding client 140. In some implementations, the at least one carrier data 114 instance, the at least one schedule data 116 instance, the at least one fare data instance, and the at least one rule 120 instance can be defined with and stored within the travel planning engine 108 as opposed to memory 107.

The client 140 may be any computing device operable to connect to or communicate with at least the travel planning server 102 using the network 130. In general, the client 140 comprises a computer operable to receive, transmit, process, and store any appropriate data associated with the example travel planning system 100. While FIG. 1 illustrates representative clients 140a-140d (collectively the client 140), the client 140 may take other forms without departing from the scope of this disclosure. For example, client 140 is intended to encompass any computing device such as a desktop computer, laptop/notebook computer, wireless data port, smart phone, personal data assistant (PDA), tablet computing device, one or more processors within these devices, or any other suitable processing device. The client 140 may include a computer that includes an input device, such as a keypad, touch screen, or other device that can accept user information, and an output device that conveys information associated with the operation of the travel planning server 102 or the client 140 itself, including digital data, visual information, or a GUI 142, as shown with respect to the client 140.

The client 140 further includes a client application 146. The client application 146 is any type of application that allows the client 140 to request and view content on the client 140. In some implementations, the client application 146 can be and/or include a web browser. In some implementations, the client application 146 can use parameters, metadata, and other information received at launch to access a particular set of data from the travel planning server 102. Once a particular client application 146 is launched, a user may interactively process a task, event, or other information associated with the travel planning server 102. Further, although illustrated as a single client application 146, the client application 146 may be implemented as multiple client applications in the client 140.

The illustrated client 140 further includes an interface 152, a processor 144, and a memory 148. The interface 152 is used by the client 140 for communicating with other systems in a distributed environment—including within the example travel planning system 100—connected to the network 130; for example, the travel planning server 102 as well as other systems communicably coupled to the network 130 (not illustrated). The interface 152 may also be consistent with the above-described interface 104 of the travel planning server 102 or other interfaces within the example distributed computing system 100. The processor 144 may be consistent with the above-described processor 106 of the travel planning server 102 or other processors within the example distributed computing system 100. Specifically, the processor 144 executes instructions and manipulates data to perform the operations of the client 140, including the functionality required to send requests to the travel planning server 102 and to receive and process responses from the travel planning server 102. The memory 148 may be consistent with the above-described memory 107 of the travel planning server 102 or other memories within the example travel planning system 100 but storing objects and/or data associated with the purposes of the client 140.

Further, the representative client 140a illustrates a GUI 142 applicable to the remainder representative clients and the client 140 in general. The GUI 142 provides a visual interface with at least a portion of the example distributed computing system 100. Generally, through the GUI 142, a travel planning server 102 user is provided with an efficient and user-friendly presentation of data provided by or communicated within the example travel planning system 100. In particular, the GUI 142 may be used to view and select available cabins per flight segment for a multi-flight-segment air-travel itinerary.

There may be any number of clients 140 associated with, or external to, the example travel planning system 100. For example, while the illustrated example travel planning system 100 includes one client 140 communicably coupled to the travel planning server 102 using network 130, alternative implementations of the example travel planning system 100 may include any number of clients 140 suitable to the purposes of the example travel planning system 100. Additionally, there may also be one or more additional clients 140 external to the illustrated portion of the example travel planning system 100 that are capable of interacting with the example travel planning system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

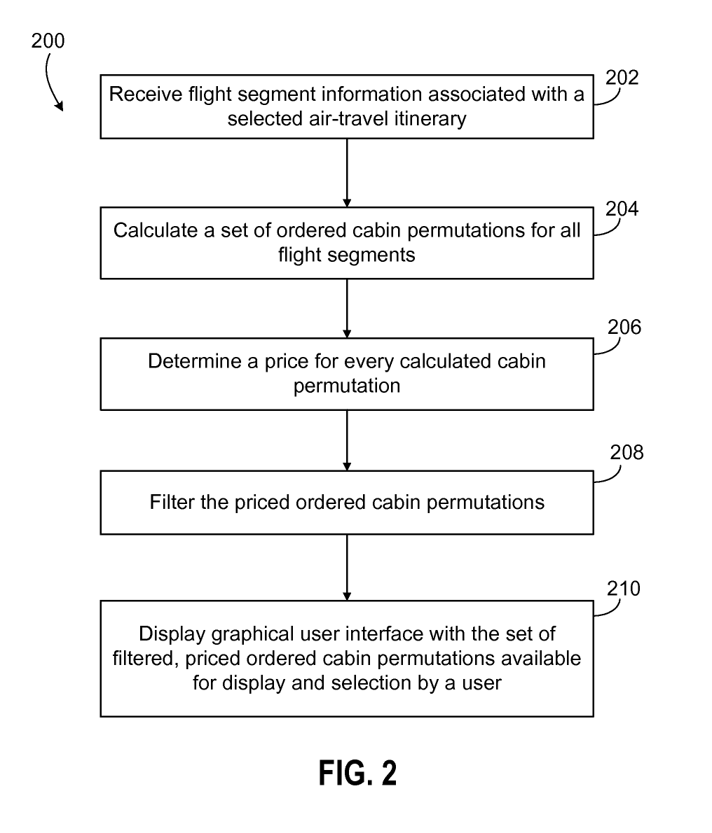

Turning now to FIG. 2, FIG. 2 is a flow chart illustrating a method 200 to calculate and filter available cabin combinations for flight segments associated with a multi-flight-segment air-travel itinerary to display on a graphical user interface. For clarity of presentation, the description that follows generally describes method 200 in the context of FIG. 1. However, it will be understood that method 200 may be performed, for example, by any other suitable system, environment, software, and hardware, or a combination of systems, environments, software, and hardware as appropriate.

At 202, flight segment information associated with a selected multi-flight-segment air-travel itinerary is received. For example, flight segment information associated with flight segments:

### 1. BOS-LAX Y/F

### 2. LAX-SYD Y/W/J/F

### 3. SYD-HBA Y/J

### 4. HBA-MEL Y/J

### 5. MEL-LAX Y/W/J/F

### 6. LAX-BOS Y/F

may be received. In this example, to focus upon the functionality pertaining to selecting available cabins per flight segment, the received flight segment information other than flight segment and available cabin types per flight segment is not shown. In some implementations, the received flight segment information can also include carrier data, schedule data, fare data, availability data, tax data, and/or other suitable data necessary to calculate at least a lowest price value at 206 below. From 202, method 200 proceeds to 204.

At 204, a set of possible ordered cabin permutations are calculated for all flight segments. For example, for the example received flight segments and available cabin types per flight segment,

### 1. BOS-LAX Y/F

### 2. LAX-SYD Y/W/J/F

### 3. SYD-HBA Y/J

### 4. HBA-MEL Y/J

### 5. MEL-LAX Y/W/J/F LAX-BOS Y/F

the number of possible ordered cabin permutations would be:

(2*4*2*2*4*2)=256

The number of available cabin types per flight segment is taken from, for example, “BOS-LAX Y/F”=2 cabin types, “LAX-SYD Y/W/J/F”=4 cabin types, and so on. In some implementations, other types of calculations may be performed, for example, a combination, etc. From 204, method 200 proceeds to 206.

At 206, a lowest price is calculated for each cabin permutation of the set of calculated ordered cabin permutations. For example, the calculated fare for the cabin permutations may be represented as:

$$1 / Y - Y - Y - Y - Y - Y / USD 2681.30$$

$$2 / Y - Y - Y - Y - Y - F / USD 16451.30$$

$$3 / Y - Y - Y - Y - W - Y / USD 3456.30$$

$$4 / Y - Y - Y - Y - W - F / USD 16451.30$$

$$5 / Y - Y - Y - J - Y - Y / USD 3112.30$$

$$…$$

$$253 / F - F - J - J - J - Y / USD 19151.30$$

$$254 / F - F - J - J - J - F / USD 25233.30$$

$$255 / F - F - J - J - F - Y / USD 25723.30$$

$$256 / F - F - J - J - F - F / USD 28239.30$$

where the first column represents a line number for later reference, the second column represents the available cabin associated with each flight segment (ordered left to right from 1-6) in the multi-flight-segment air-travel itinerary journey, and the third column shows the lowest fare price for the represented cabin permutation. For example, for line 256, flight segments 1-2-3-4-5-6 would have cabin types F-F-J-J-F-F assigned, respectively, with a lowest price of USD $28239.30 for this seating arrangement while for line 1, flight segments 1-2-3-4-5-6 would have cabin types Y-Y-Y-Y-Y-Y assigned, respectively, with a lowest price of USD $2681.30 for this seating arrangement. From 206, method 200 proceeds to 208.

At 208, the set of priced ordered cabin permutations are filtered. For example, for lines 2 and 4, line 4 allows a passenger to sit in the same or better cabin for all flight segments for the same fare price. Therefore, line 2 may be deemed unnecessary and removed from the set of priced ordered cabin permutations for the multi-flight-segment air-travel itinerary. In some implementations, every line is compared at least against every other line until all remaining lines are not directly comparable with each other, meaning no line is considered “superior” to any of the others (as in the initial comparison of lines 2 and 4 above) and each of the remaining lines represent a trade-off between seat comfort and/or fare price that may be chosen by a user. For example, lines 2 and 255 above are not directly comparable in that neither allows seating in the same or better cabin for all flight segments (note flight segment 6 of ‘F’ in line 2 is better than ‘Y’ in line 255). Priced ordered cabin permutations may be filtered using other criteria, such as duplicates or other suitable criteria. From 208, method 200 proceeds to 210.

At 210, a mechanism is provided for exploring the filtered, priced, ordered cabin permutations, for example a GUI. In the case of a GUI, the GUI is displayed with the set of filtered, priced, ordered cabin permutations available for display and selection by a user. After 210, method 200 stops.

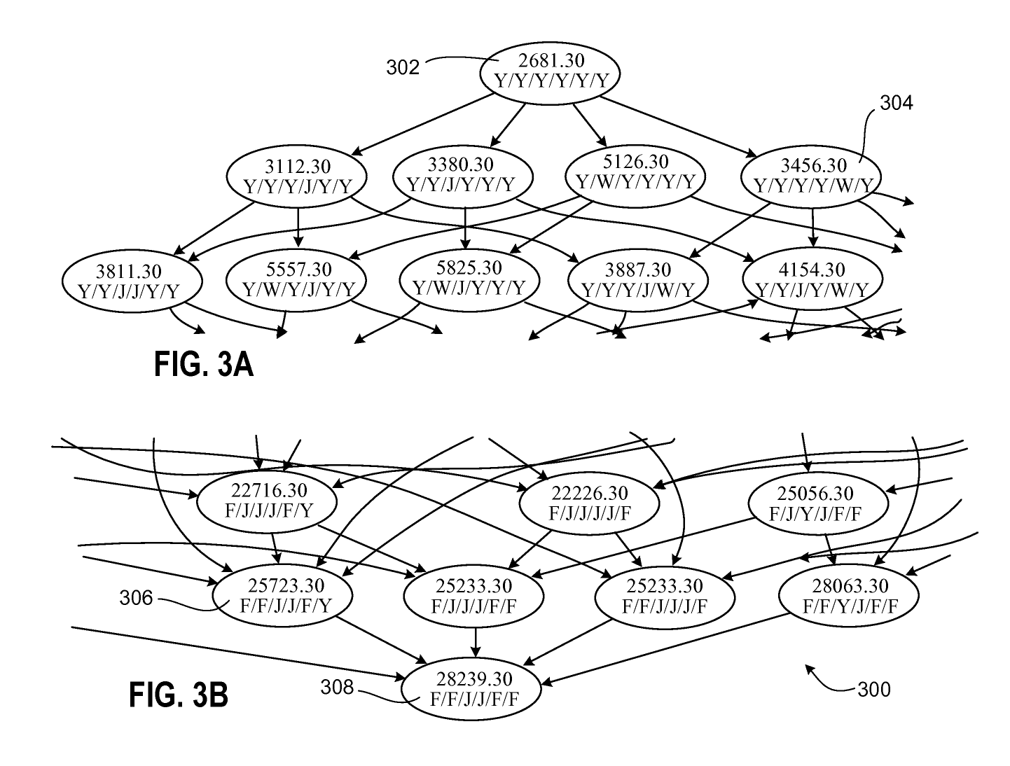

Turning now to FIG. 3A, FIG. 3A is a block diagram illustrating an example partial set of and relationships between filtered, priced, ordered cabin permutations 300 for flight segments associated with a multi-flight-segment air-travel itinerary following the method of FIG. 2. For example, line 1 of the calculated ordered permutations is represented by 302. Likewise line 3 is represented by 304. For line 1, 302 indicates that the priced, ordered cabin combination has a fare of $2681.30 and a selected cabin type of ‘Y’ for each of the six flight segments making up the round trip multi-flight-segment air-travel itinerary. For line 3, 304 indicates that the priced, ordered cabin combination has a fare of $3456.30 for a selected cabin type of ‘Y’ for flight segments 1, 2, 3, 4, and 6 and a selected cabin type of ‘W’ for flight segment 5 (i.e., the MEL-LAX return flight segment). A direct relationship is shown between 302 and 304 because a single permutation is required to move from the permutation value of 302 to the permutation value of 304 (i.e., the cabin for flight segment 5 is set as ‘W’ instead of ‘Y’). The relationship between 302 and 304 is shown with a unidirectional arrow, indicating that the state may be transitioned between 302 and 304 from 302 to 304 only. In some implementations, the relationships can be represented in whole or in part by bidirectional arrows and transitions between states may occur in either direction. Turning now to FIG. 3B, FIG. 3B is a block diagram illustrating additional cabin permutations and relationships of the example filtered, priced, ordered cabin permutations 300 for flight segments associated with a multi-flight-segment air-travel itinerary following the method of FIG. 2. For example, line 255 of the calculated ordered permutations is represented by 306 and line 256 is represented by 306. For line 256, 308 indicates that the priced, ordered cabin permutation has a fare of $28239.30 and a selected cabin type of “F/F/J/J/F/F” for each of the six flight segments, respectively. The selected cabin types indicate a “First” class cabin for flight segments BOS-LAX and LAX-SYD, a “Business” class cabin for flight segments SYD-HBA and HBA-MEL, and then a “First” class cabin for the final flight segments MEL-LAX and LAX-BOS. The example partial set of filtered, priced, ordered cabin permutations and relationships illustrated in FIGS. 3A and 3B do not represent all filtered, priced, ordered cabin permutations and are to be considered as representative only. One of ordinary skill will appreciate that in other implementations, the illustrated values, grouping, and/or relationships can be represented in numerous other ways without departing from the scope of this disclosure.

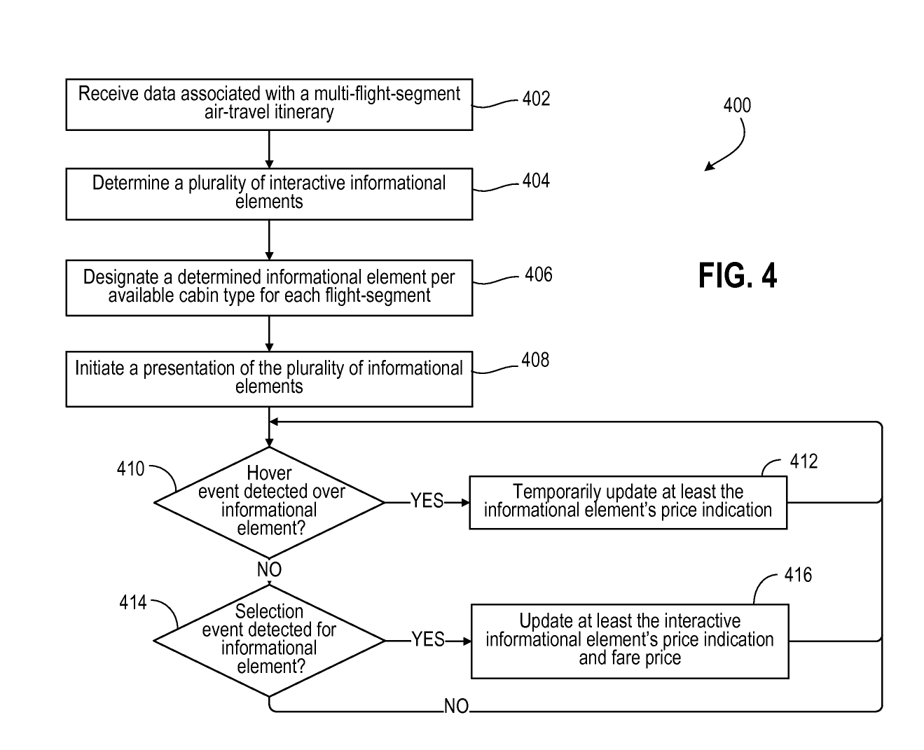

Turning now to FIG. 4, FIG. 4 is a flow chart 400 illustrating a method of displaying information for a multi-flight-segment air-travel itinerary. For clarity of presentation, the description that follows generally describes method 400 in the context of FIGS. 1, 2, and 3. However, it will be understood that method 400 may be performed, for example, by any other suitable system, environment, software, and hardware, or a combination of systems, environments, software, and hardware as appropriate.

At 402, data associated with a multi-flight-segment air-travel itinerary is received. In some implementations, the received data can include, for example, flight-segment data, available cabin types per flight segment, flight segment price data, and/or other suitable data associated with a multi-flight-segment air-travel itinerary. From 402, method 400 proceeds to 404.

At 404, a plurality of interactive information elements to be displayed on a GUI is determined. Each interactive informational element indicates an available cabin type for a flight segment. In some implementations, each interactive informational element can include a price indication, an image, and/or other information conveying symbols, text, etc. For example, a determined interactive informational element may have a price of “+13004*” and an image of a reclined stick-type person within the element. The price indication of “+13004*” would indicate that selecting this informational element would add $13004.00 to the fare of the air-travel itinerary. Likewise, a price indication of “−13004” would indicate that selecting the information element would result in a drop of $13004.00 from the fare for the air-travel itinerary. The asterisk symbol (or other suitable symbol) indicates that selecting this informational element would affect one or more other informational elements in some way. The one or more other informational elements may be affected, for example, by being selected automatically, having their price indication updated to a higher or lower amount, etc. In some implementations, the price indication can indicate “(Included)” or other similar label to indicate that the informational element is currently selected and included as part of the cabin selections for the air-travel flight itinerary. From 404, method 400 proceeds to 406.

At 406, an informational element per available cabin type for each flight segment is designated. From 406, method 400 proceeds to 408.

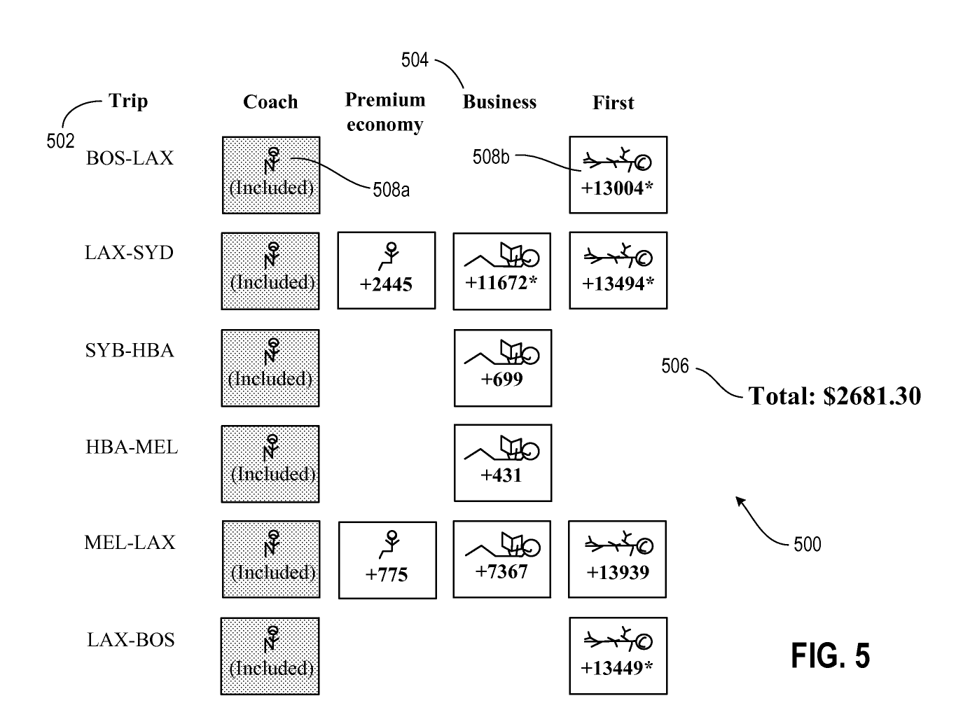

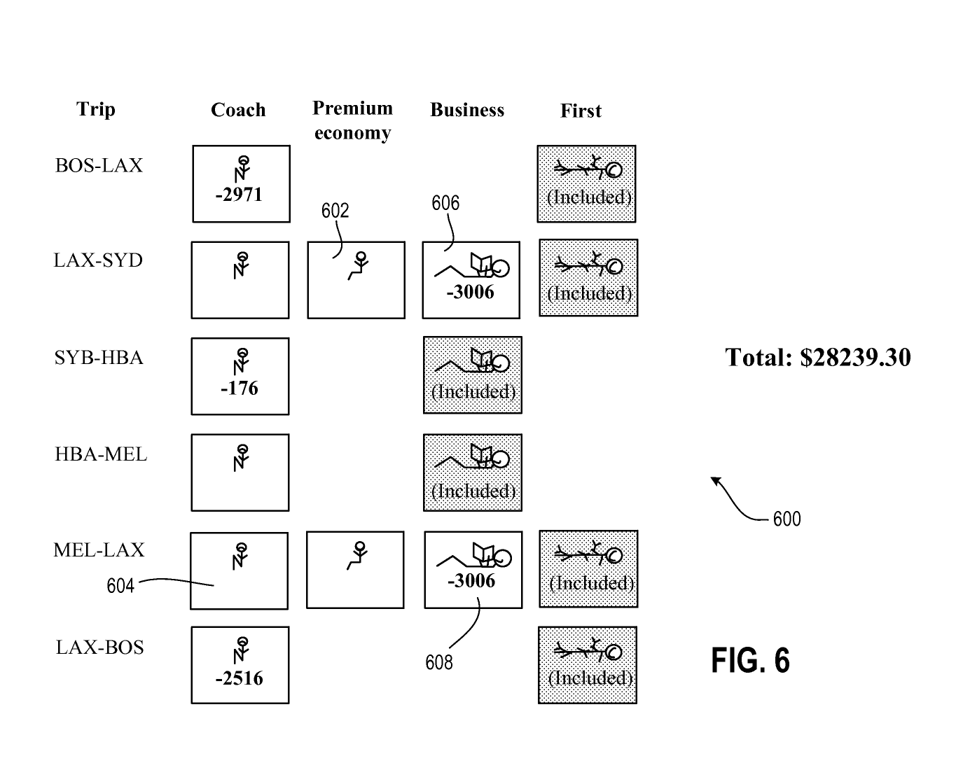

At 408, a presentation of the plurality of interactive informational elements is initiated. In some implementations, the interactive informational elements are displayed on a GUI. In some implementations, the interactive informational elements are displayed as part of a single GUI. In some implementations, the interactive informational elements are simultaneously presented. Referring now to FIG. 5, FIG. 5 is a block diagram illustrating an example GUI 500 displaying a plurality of determined interactive informational elements. The individual flight segments making up the “Trip” (i.e., air-travel itinerary) are shown at 502 down the left side of the GUI. Flight segments include “BOS-LAX,” “LAX-SYD,” “SYD-HBA,” etc. Cabin types are shown across the top of the example GUI at 504. Cabin types for the example GUI include “Coach,” “Premium economy,” “Business,” and “First.” Displayed cabin types may vary depending upon the received data associated with the multi-flight-segment air-travel itinerary. A fare for the multi-flight-segment air-travel itinerary is shown at 506. In some implementations, the presented designated interactive informational elements initially indicate a lowest-cost cabin type option for the associated air-travel itinerary. Note that the example GUI 500 illustrates the line 1 calculated, ordered cabin permutation described above with respect to FIG. 2, 208 and fare/cabin type selections of “Y” for each of the six flight segments illustrated at 302 in FIG. 3A (the lowest cost option available for cabin type selections). In other implementations, other cabin type selections may be initially indicated, for example, the most expensive cabin type option, or a middle-of-the-road cabin type option. Referring now to FIG. 6, FIG. 6 is a block diagram illustrating an example GUI 600 displaying a plurality of different determined interactive informational elements. In FIG. 6, the initially indicated cabin type selections reflect the highest-cost option available for cabin-type selections. Note that the example GUI 600 illustrates the line 256 calculated, ordered cabin permutation described above with respect to FIG. 2, 208 and fare/cabin type selections of “F-F-J-J-F-F” for each of the six flight segments, respectively, illustrated at 308 in FIG. 3B. In FIG. 6, some informational elements, for example 602 and 604, display no price indication. In some implementations, the price indication is omitted from display on informational elements because options presented by informational elements 602 and 604 are determined to be inferior to the options presented by other informational elements within the same flight segment, for example 606 and 608, respectively, because they would place the user into a lower class of service, but at the same or higher price than the currently selected informational element. In some implementations, the user may select an inferior option if desired.

Returning now to FIG. 5, in some implementations, as shown, the above-described interactive information elements are arranged in a grid-type pattern within the GUI 500. For example, for flight segment “BOS-LAX,” an interactive information element 508a for the “Coach” cabin type and an interactive information element 508b for the “First” cabin type are displayed. For this flight segment, the “Premium economy” and “Business” cabin types are not available. However, for the “LAX-SYD” flight segment, an interactive informational element is displayed for all cabin types as all cabin types are available for selection for this flight segment. The illustrated example GUIs 500 and 600 are to be considered representative only, and one of ordinary skill will appreciate that in other implementations, the GUIs 500/600 and/or interactive informational elements may be represented in numerous other ways without departing from the scope of the disclosure. Returning now to FIG. 4, from 408, method 400 proceeds to 410.

At 410, a determination is made whether a hover event is detected for an interactive informational element. If at 410, it is determined that a hover event is not detected, method 400 proceeds to 414. If at 410, however, it is determined that a hover event is detected, method 400 proceeds to 412 where at least the interactive informational element associated with the hover event has its associated price indication temporarily updated. In some implementations, a hover event may refer to a mouse over event or other similar type of event generated by a GUI when a first GUI graphical object, for example a mouse pointer, is placed over a second GUI graphical object, for example an interactive informational element, a menu selector, etc.

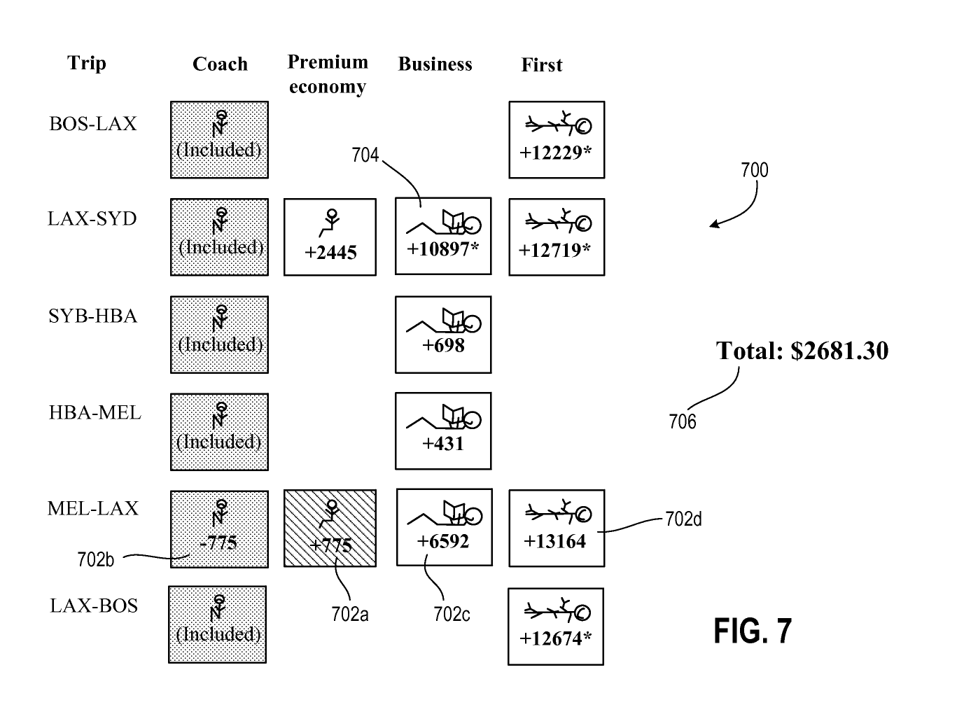

Referring now to FIG. 7, FIG. 7 is a block diagram illustrating an example GUI 700 displaying updated interactive informational elements following the detection of a hover event. Interactive informational element 702a is shown highlighted due to the detection of a hover event. Additionally, the hover event triggers a temporary update of price indications for other interactive informational elements, for example 702b, 702c, 702d, and 704. The hover event informs a user that if interactive informational element 702a is selected the displayed price indications on the other interactive informational elements will remain as displayed. Note for the interactive informational element 702b, the “(Included)” price indication has been replaced with “−775” indicating that selecting 702b would reduce the fare 706 by $775. In some implementations, the fare 706 may also temporarily update to reflect a new fare on the detection of a hover event. In other implementations, the fare 706 updates following a selection of an interactive informational element.

In this example, following the detection of the end of the hover event (e.g., a no-hover event), the temporarily updated price indications for associated interactive informational elements will return to their pre-hover-event detection state. For the example of FIG. 7, once a no-hover event is detected with respect to interactive informational element 702a, the GUI may revert to the values displayed in FIG. 5 for all interactive informational elements. In some implementations, the fare 706 may also return to a pre-hover-event detection state as illustrated in FIG. 5 upon the detection of a no-hover event.

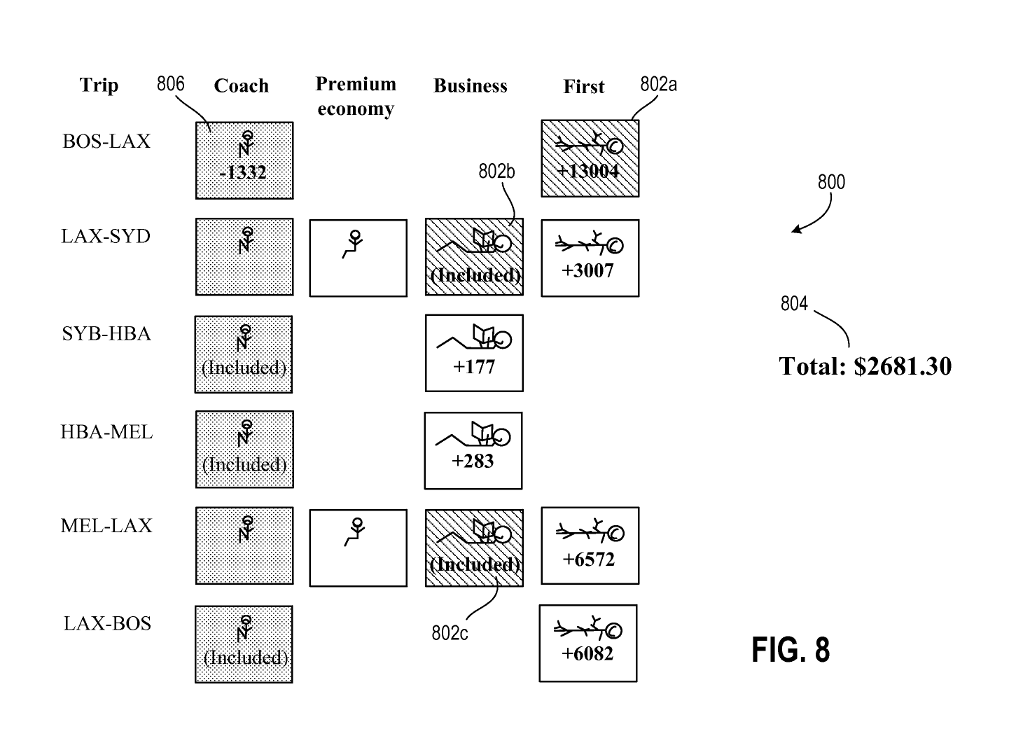

Referring now to FIG. 8, FIG. 8 is a block diagram illustrating an example GUI 800 displaying updated interactive informational elements following the detection of a hover event. Interactive informational element 802a is shown highlighted due to the detection of a hover event. Additionally, the hover event for interactive informational element 802a triggers not only a temporary update of price indications for other interactive informational elements, but also specifically designates interactive informational elements 802b and 802c. The asterisk symbol (or other suitable symbol) displayed with informational element 802a indicates that selecting this informational element would affect one or more other informational elements in some way, here interactive informational elements 802b and 802c. In this example, by hovering over interactive informational element 802a, interactive informational elements 802b and 802c are designated to be “(Included”) as cabin types in the air-travel itinerary if the interactive informational element 802a is selected. In other words, if a user selects interactive informational element 802a, for the LAX-SYD and MEL-LAX flight segments, the user would receive an “upgrade” from a cabin type of “Coach” to a cabin type of “Business” if a cabin type of “First” is selected for the BOS-LAX flight segment. In some implementations, the specific designation can include bolding, highlighting, color change, sound, motion associated with the interactive informational element, and/or other suitable designation methods. In some implementations, the fare 804 may also temporarily update to reflect a new fare on the detection of a hover event. In some implementations, selecting an interactive informational element, for example 806 to lower cost by $1332, can result in a “downgrade” in seating for other flight segments. In some implementations, as discussed above with respect to FIG. 6, the price indication is omitted from display on informational elements because options presented by the informational elements are determined to be inferior to the options presented by other informational elements within the same flight segment. In some implementations, the user may select an inferior option if desired. Returning now to FIG. 4, after 412, method 400 returns to 410.

At 414, a determination is made whether a selection event is detected for an interactive informational element. If at 414, it is determined that a selection event is not detected, method 400 proceeds to 410. If at 414, however, it is determined that a selection event is detected, method 400 proceeds to 416 where at least the interactive informational element associated with the selection event has its associated price indication updated and the fare price is updated. In some implementations, selecting a particular interactive informational element results in updates to one or more interactive informational elements, for example, a change in the pricing indication for the one or more interactive informational elements. In some implementations, a selection event may refer to a mouse-click, multi-touch event, voice activation or other similar type of selection event generated by a GUI using a computer mouse, a touchscreen, voice recognition software, a stylus, a keyboard, or other suitable method of selecting a graphical item on a GUI. After 414, method 400 returns to 410.

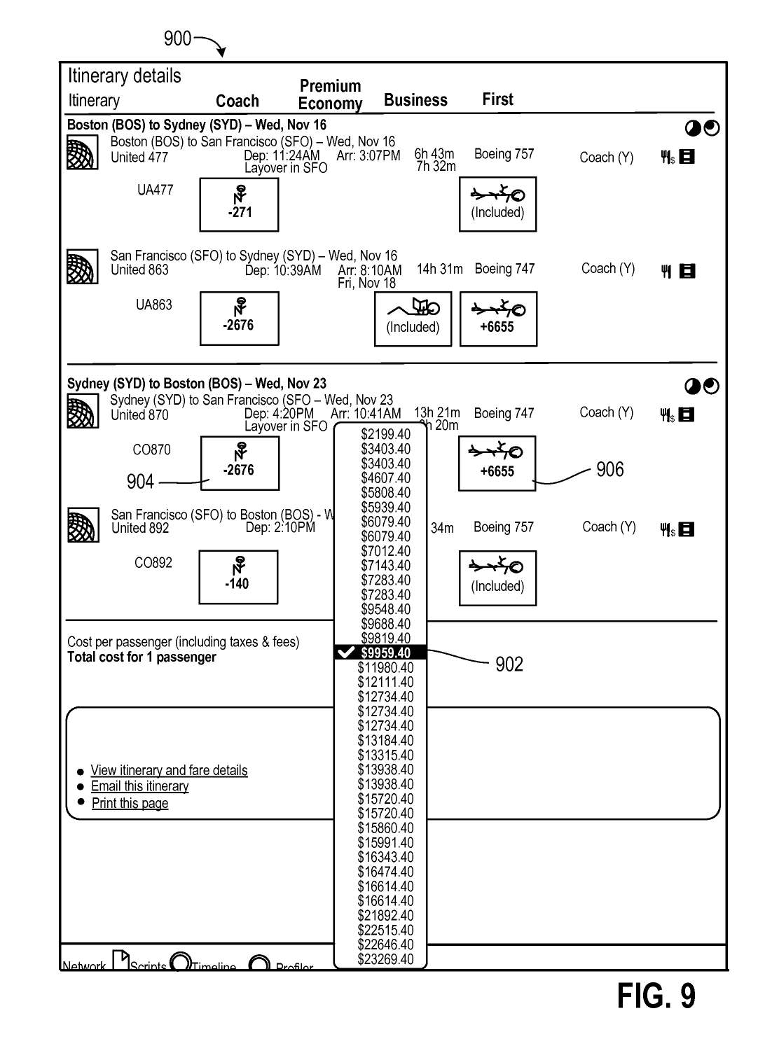

Referring now to FIG. 9, FIG. 9 is a block diagram illustrating an example alternate GUI illustrating the temporary updating of informational elements by indicating a desired fare for the represented air-travel itinerary. In some implementations, a user indication can be a hover event or other suitable non-selecting indication. This functionality may prove useful if a user wishes or is required to restrict the cost of travel according to a budget. Allowing the user to indicate a fare allows the user to quickly indicate various fares to determine the best available seating for the indicated fares. Once a fare is selected by the user, the user then has an option to “fine tune” cabin-type selections to see how the selections would affect the fare for the air-travel itinerary. For example, for a four flight segment air-travel itinerary with designated cabin types of “Coach” for each flight segment:

1. BOS-SFO—cabin type “Coach”
2. SFO-SYD—cabin type “Coach”
3. SYD-SFO—cabin type “Coach”
4. SFO-BOS—cabin type “Coach”
if a user indicates a desired fare 902 of “$9959.40,” the example GUI 900 indicates to a user that the cabin type assignments for each of four flight segments would be:
1. BOS-SFO—cabin type of “First”
2. SFO-SYD—cabin type of “Business”
3. SYD-SFO—cabin type of “Business”
4. SFO-BOS—cabin type of “First”
The user could then select the indicated fare to set the cabin types as indicated by the GUI 900. To save money, the user could then select the “Coach” cabin type interactive informational element 904 for the SYD-SFO flight segment in order to cut $2676 from the fare. Similarly, the user could select the “First” cabin type interactive information element 906 to upgrade the SYDBOS flight segment cabin type for an extra “$6655” added to the fare.

As will be apparent to those skilled in the art, example method 400 and example GUIs illustrated in FIGS. 5-9 are for representative purposes only and are not meant to limit the disclosure in any way. Consistent with this disclosure, various other GUI implementations and associated methods for displaying and selecting flight segments for an air-travel itinerary could be implemented without departing from the scope of the disclosure.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, subprograms, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program include, by way of example, can be based on general and/or special purpose microprocessors, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a standalone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method to render graphical user interfaces comprising multiple, interrelated components generated in response to a request for an air travel itinerary, comprising:
receiving, using one or more computing devices and from a user computing device, a request for an air-travel itinerary comprising a plurality of flight segments;
identifying, using one or more computing devices, one or more air-travel solutions associated with an air-travel itinerary, each air-travel solution including a plurality of flight segment identifiers associated with one or more flights, each flight segment identifier associated with one or more user-selectable cabin type identifiers, each user-selectable cabin type identifier having an associated value associated with a feature;
determining, using the one or more computing devices, a cabin type identifier having a lowest associated value associated with the feature for each flight segment identifier based on the one or more air-travel solutions;
designating, using the one or more computing devices, an initial cabin type identifier for each flight segment identifier based on the determined cabin type identifier having the lowest associated value associated with the feature, wherein the designated initial cabin type identifier represents a currently selected cabin type identifier for each flight segment identifier;
providing, using the one or more computing devices, instructions to the user computing device causing the user computing device to render a graphical user interface, the graphical user interface comprising:
a grid comprising one or more cabin type identifiers along a horizontal axis and one or more flight segment identifiers along a vertical axis;
one or more interactive information elements arranged in the grid, each of the one or more interactive information elements representing a particular cabin type identifier corresponding to a particular flight segment identifier, wherein the designated initial cabin type identifier is depicted as the currently selected cabin type identifier for each flight segment identifier in the graphical user interface;
at a time after presenting the graphical user interface, receiving, using the one or more computing devices and from the user computing device, an input of a selection of a first interactive information element in the graphical user interface representing a first cabin type identifier corresponding to a first flight segment identifier, the first cabin type identifier associated with the selected interactive information element for the first flight segment identifier being different than the designated initial cabin type for the first flight identifier; and
in response to receiving the input of a selection of the interactive informational element associated with the first cabin type identifier corresponding to the first flight segment identifier, providing, using the one or more computing devices, instructions to the user computing device causing the user computing device to render an updated graphical user interface, the updated graphical user interface comprising:
the grid comprising the one or more cabin type identifiers along the horizontal axis and the one or more flight segment identifiers along the vertical axis;
one or more interactive information elements arranged in the grid, each of the one or more interactive information elements representing a particular cabin type identifier corresponding to a particular flight segment identifier, wherein the first cabin type identifier associated with the selected interactive information element is depicted as the currently selected cabin type identifier for the first flight segment identifier in the graphical user interface, and wherein the designated initial cabin type identifier is depicted as the currently selected cabin type identifier for a second flight segment identifier in the graphical user interface.

2. The computer-implemented method of claim 1, wherein the updated graphical user interface further comprises a value associated with the feature associated with the selected interactive informational element associated with the first cabin type identifier corresponding to the first flight segment identifier.

3. The computer-implemented method of claim 1, wherein the updated graphical user interface further comprises a value associated with the feature associated with a second interactive informational element associated with a second cabin type identifier corresponding to a second flight segment identifier, the second cabin type identifier being different than the first cabin type identifier.

4. The computer-implemented method of claim 1, wherein each of the one or more interactive informational elements displays, in the graphical user interface, as an indication of the value associated with the feature, at least one of an indication that the represented available cabin type is included in the multi-flight-segment air-travel itinerary price or a difference of the value associated with the feature indicating a change in the value associated with the feature associated with the multi-flight-segment air travel itinerary if the interactive informational element is selected.

5. The computer-implemented method of claim 4, further comprising updating, in the graphical user interface, the indication of the value associated with the feature from a first value to a second value for at least one interactive informational element upon receiving a selection event associated with the another interactive informational element, wherein the received selection event designates the another interactive informational element.

6. The computer-implemented method of claim 4, further comprising designating, in the graphical user interface, at least one interactive informational element with another interactive informational element upon receiving a selection event associated with the another interactive informational element, wherein the received selection event designates the another interactive informational element.

7. The computer-implemented method of claim 6, further comprising updating, in the graphical user interface, the indication of the value associated with the feature for the designated at least one interactive informational element.

8. A system, comprising:
one or more computing devices operable to perform operations to render graphical user interfaces comprising multiple, interrelated components generated in response to a request for an air travel itinerary, comprising:
receiving, from a user computing device, a request for an air-travel itinerary comprising a plurality of flight segments;
identifying one or more air-travel solutions associated with an air-travel itinerary, each air-travel solution including a plurality of flight segment identifiers associated with one or more flights, each flight segment identifier associated with one or more user-selectable cabin type identifiers, each user-selectable cabin type identifier having an associated value of a feature;
determining a cabin type identifier having a lowest value of the associated feature for each flight segment identifier based on the one or more air-travel solutions;
designating an initial cabin type identifier for each flight segment identifier based on the determined cabin type identifier having the lowest associated value of the feature, wherein the designated initial cabin type identifier represents a currently selected cabin type identifier for each flight segment identifier;
providing instructions to the user computing device causing the user computing device to render a graphical user interface, the graphical user interface comprising:
a grid comprising one or more cabin type identifiers along a horizontal axis and one or more flight segment identifiers along a vertical axis;
one or more interactive information elements arranged in the grid, each of the one or more interactive information elements representing a particular cabin type identifier corresponding to a particular flight segment identifier, wherein the designated initial cabin type identifier is depicted as the currently selected cabin type identifier for each flight segment identifier in the graphical user interface;
at a time after presenting the graphical user interface, receiving from the user computing device, an input of a selection of a first interactive information element in the graphical user interface representing a first cabin type identifier corresponding to a first flight segment identifier, the first cabin type identifier associated with the selected interactive information element for the first flight segment identifier being different than the designated initial cabin type for the first flight identifier; and
in response to receiving the input of a selection of the interactive informational element associated with the first cabin type identifier corresponding to the first flight segment identifier, providing instructions to the user computing device causing the user computing device to render an updated graphical user interface, the updated graphical user interface comprising:
the grid comprising the one or more cabin type identifiers along the horizontal axis and the one or more flight segment identifiers along the vertical axis;
one or more interactive information elements arranged in the grid, each of the one or more interactive information elements representing a particular cabin type identifier corresponding to a particular flight segment identifier, wherein the first cabin type identifier associated with the selected interactive information element is depicted as the currently selected cabin type identifier for the first flight segment identifier in the graphical user interface, and wherein the designated initial cabin type identifier is depicted as the currently selected cabin type identifier for a second flight segment identifier in the graphical user interface.

9. The system of claim 8, wherein the updated graphical user interface further comprises a value of the feature associated with the selected interactive informational element associated with the first cabin type identifier corresponding to the first flight segment identifier.

10. The system of claim 8, wherein the updated graphical user interface further comprises a value of the feature associated with a second interactive informational element associated with a second cabin type identifier corresponding to a second flight segment identifier, the second cabin type identifier being different than the first cabin type identifier.

11. The system of claim 8, wherein each of the one or more interactive informational elements displays, in the graphical user interface, as an indication of the value of the feature, at least one of an indication that the represented available cabin type is included in the value of the feature associated with the multi-flight-segment air-travel itinerary or a difference associated with the feature indicating a change in the value of the multi-flight-segment air travel itinerary feature if the interactive informational element is selected.

12. The system of claim 11, further comprising updating, in the graphical user interface, the indication of the value of the feature from a first value to a second value for at least one interactive informational element upon receiving a selection event associated with the another interactive informational element, wherein the received selection event designates the another interactive informational element.

13. The system of claim 11, further comprising designating, in the graphical user interface, at least one interactive informational element with another interactive informational element upon receiving a selection event associated with the another interactive informational element, wherein the received selection event designates the another interactive informational element.

14. The system of claim 13, further comprising updating, in the graphical user interface, the price indication for the designated at least one interactive informational element.

15. A computer storage medium encoded with a computer program, the program comprising instructions that when executed by a data processing apparatus cause the data processing apparatus to render graphical user interfaces comprising multiple components generated in response to a request for an air travel itinerary, comprising:
receiving, from a user computing device, a request for an air-travel itinerary comprising a plurality of flight segments;
identifying one or more air-travel solutions associated with an air-travel itinerary, each air-travel solution including a plurality of flight segment identifiers associated with one or more flights, each flight segment identifier associated with one or more user-selectable cabin type identifiers, each user-selectable cabin type identifier having an associated value of a feature;
determining a cabin type identifier having a lowest associated value of the feature for each flight segment identifier based on the one or more air-travel solutions;
designating an initial cabin type identifier for each flight segment identifier based on the determined cabin type identifier having the lowest associated value of the feature, wherein the designated initial cabin type identifier represents a currently selected cabin type identifier for each flight segment identifier;
providing instructions to the user computing device causing the user computing device to render a graphical user interface, the graphical user interface comprising:
a grid comprising one or more cabin type identifiers along a horizontal axis and one or more flight segment identifiers along a vertical axis;
one or more interactive information elements arranged in the grid, each of the one or more interactive information elements representing a particular cabin type identifier corresponding to a particular flight segment identifier, wherein the designated initial cabin type identifier is depicted as the currently selected cabin type identifier for each flight segment identifier in the graphical user interface;
at a time after presenting the graphical user interface, receiving from the user computing device, an input of a selection of a first interactive information element in the graphical user interface representing a first cabin type identifier corresponding to a first flight segment identifier, the first cabin type identifier associated with the selected interactive information element for the first flight segment identifier being different than the designated initial cabin type for the first flight identifier; and
in response to receiving the input of a selection of the interactive informational element associated with the first cabin type identifier corresponding to the first flight segment identifier, providing instructions to the user computing device causing the user computing device to render an updated graphical user interface, the updated graphical user interface comprising:
the grid comprising the one or more cabin type identifiers along the horizontal axis and the one or more flight segment identifiers along the vertical axis;
one or more interactive information elements arranged in the grid, each of the one or more interactive information elements representing a particular cabin type identifier corresponding to a particular flight segment identifier, wherein the first cabin type identifier associated with the selected interactive information element is depicted as the currently selected cabin type identifier for the first flight segment identifier in the graphical user interface, and wherein the designated initial cabin type identifier is depicted as the currently selected cabin type identifier for a second flight segment identifier in the graphical user interface.

16. The computer storage medium of claim 15, wherein the updated graphical user interface further comprises a value of the feature associated with the selected interactive informational element associated with the first cabin type identifier corresponding to the first flight segment identifier.

17. The computer storage medium of claim 15, wherein the updated graphical user interface further comprises a value of the feature associated with a second interactive informational element associated with a second cabin type identifier corresponding to a second flight segment identifier, the second cabin type identifier being different than the first cabin type identifier.

18. The computer storage medium of claim 15, wherein each of the one or more interactive informational elements displays, in the graphical user interface, as an indication of a value of the feature, at least one of an indication that the represented available cabin type is included in the value of the feature associated with the multi-flight-segment air-travel itinerary or a difference in value of the feature indicating a change in the value of the feature associated with the multi-flight-segment air travel itinerary if the interactive informational element is selected.

19. The computer storage medium of claim 18, further comprising updating, in the graphical user interface, the indication of the value of the feature from a first value to a second value for at least one interactive informational element upon receiving a selection event associated with the another interactive informational element, wherein the received selection event designates the another interactive informational element.

20. The computer storage medium of claim 18, further comprising designating, in the graphical user interface, at least one interactive informational element with another interactive informational element upon receiving a selection event associated with the another interactive informational element, wherein the received selection event designates the another interactive informational element.
